(19) United States
(12) Patent Application Publication
(10) Pub. No.: US 2018/0352376 A1
(43) Pub. Date: Dec. 6, 2018

(54) LOCATION FINGERPRINTING

(71) Applicant: HERE Global B.V., Eindhoven (NL)

(72) Inventors: Michael V Shuman, Chicago, IL (US); Sergey Mironov, Cambridge, MA (US)

(21) Appl. No.: 15/610,004

(22) Filed: May 31, 2017

(51) Int. Cl. H04W 4/02; H04W 4/04; G06F 17/30

(52) U.S. Cl. CPC H04W 4/023; G06F 17/30241; H04W 4/046; H04W 4/028

(57) ABSTRACT

Embodiments include apparatus and methods for creating and/or using location fingerprints. A location fingerprint includes sensor criteria associated with a location. Sensor criteria includes sensor data associated with, and indicative of, a location. Sensor criteria also includes at least one threshold related to the sensor data associated with the location. A location fingerprint is used to verify a device location by comparing the sensor criteria associated with the purported device location to sensor data received from the device at the actual device location. The device location is verified when the sensor data from the actual device location meets or exceeds the sensor criteria of the purported location.

### FIELD

The following disclosure relates to location referencing and verification, or more particularly, location referencing and verification using geospatial or environmental sensors.

### BACKGROUND

Most modern mobile devices, including cars, have some location tracking capability, such as a Global Positioning System (GPS). Typically, to determine or verify the location of a device, a system using GPS tracking is utilized to request the precise GPS coordinates of the device in order to determine or verify its location. However, there may be many sources of error in the accuracy of these GPS coordinates. Some of these errors are due to natural causes and some are intentional. The following embodiments solve these challenges of relying on GPS coordinates alone to determine or verify a device location.

### SUMMARY

In one embodiment, a method is provided for verifying a device location. A predefined location fingerprint for a purported location is accessed. The predefined location fingerprint includes sensor criteria associated with the purported location. The sensor criteria includes at least one threshold and the at least one threshold relates to sensor data associated with the purported location. Device sensor data from one or more device sensors of a device is requested. The requested device sensor data is received from the device. The received device sensor data is compared with the at least one threshold relating to the sensor data associated with the purported location. Based on this comparison, the device location is verified in response to the received device sensor data meeting or exceeding the at least one threshold.

In another embodiment, an apparatus is provided. The apparatus includes a database, a location fingerprint associated with a location, and at least one processor. The location fingerprint includes sensor criteria associated with the location and is stored in the database. The at least one processor accesses the location fingerprint from the database, pings a device for device sensor data based on the sensor criteria of the location fingerprint, receives device sensor data from the device, compares the received device sensor data with external source data associated with the location, and verifies the device is at the location based on the compared device sensor data and external source data.

In another embodiment, a method is provided for creating a location fingerprint. A location to associate with the location fingerprint is identified. Sensor criteria is selected for the location. The sensor criteria includes a set of sensor data from a plurality of sensor data associated with the location and at least one threshold relating to the set of sensor data associated with the location. The sensor criteria is associated with the location as the location fingerprint. The location fingerprint is stored in a database.

In another embodiment, an apparatus is provided. The apparatus includes a database, a communication interface, and at least one controller coupled to the communication interface and database. The communication interface receives at least one selection of a location and at least one selection of sensor criteria for the location. The at least one controller associates the at least one selection of the location and the at least one selection of sensor criteria with the location as a location profile. The at least one controller stores the location profile in the database.

### BRIEF DESCRIPTION OF THE DRAWINGS

Exemplary embodiments of the present invention are described herein with reference to the following drawings.

FIG. 1 illustrates an example system for location fingerprinting.

FIG. 2 illustrates an exemplary vehicle of the system of FIG. 1.

FIG. 3 illustrates an example location fingerprint.

FIGS. 4A and 4B illustrate example locations used for location fingerprinting.

FIG. 5 illustrates an exemplary mobile device of the system of FIG. 1.

FIG. 6 illustrates an example server.

FIG. 7 illustrates an example geographic database.

FIG. 8 illustrates an example geographic database.

FIGS. 9A and 9B illustrate an example flowcharts for creating the location fingerprint of FIG. 3.

FIG. 10 illustrates an example flowchart for using the location fingerprint of FIG. 3 to verify a device location.

### DETAILED DESCRIPTION

A device using GPS technology may determine the location of the device in a variety of ways. For example, GPS technology may use triangulation, or trilateration, to determine an absolute or relative location of the device location using a GPS receiver in the device and three or more satellites of a network of satellites by measuring the distances between the device and the satellites. While GPS tracking may provide relatively specific latitude and longitude coordinates, there are several problems or disadvantages to relying on GPS alone. For instance, GPS technology relies on GPS receivers in devices communicating with satellites in space using signals, and if the signal strength is weak, for instance whenever the GPS device does not have a clear view of the sky, the GPS device may not be able to receive its accurate location from the satellites. Problems with GPS hardware, such as antennas, batteries, or microchips of the GPS device, may also contribute to poor signal strength. The software used, including algorithms and software code, may also lead to errors in GPS accuracy.

Environmental factors may contribute to poor signal strength. The environmental factors may be natural. For example, dense cloud cover, heavy tree cover, and mountains or steep hills may negatively impact, or even interrupt, the GPS signal between the GPS receiver in the device and the satellites. For similar reasons, GPS devices may not work well, if at all, when they are located underground, such as in caves, tunnels, or in basements of buildings, as well as underwater. Atmospheric conditions may also affect the GPS signals as they travel from the satellites in space to the GPS receiver on Earth, particularly as the GPS signals pass through the ionosphere. Solar flares may affect signal reception and humidity and atmospheric pressure may also cause signal errors.

Environmental factors affecting GPS signals may also be artificial, including man-made structures such as tall buildings, bridges, and areas with strong man-made electromagnetic frequencies. For this reason, urban areas, for example, are particularly prone to GPS signal error since the tall buildings, the many reflective surfaces, and the presence of interfering frequencies, such as electromagnetic frequencies or radio signals, may affect the GPS signal strength. GPS devices under bridges or below street level, such as in subway tunnels or below-ground floors of buildings, may not have adequate signal strength to receive accurate GPS coordinate data.

Another example of artificial interference of GPS signals is intentional jamming of the GPS signal, or intentional misrepresentation of GPS coordinate data. Advancements in technology and software have enabled users to figure out various ways to either jam a GPS signal or have a device report a false location. This misrepresentation of a device location is known as GPS spoofing. GPS spoofing presents serious security risks, especially with the advancement of autonomous vehicles such as driver-less cars and drones. People using GPS spoofing to use these types of devices, or manipulate these devices, for potential hostile purposes or fraudulent activity poses a significant security issue.

There are few current safeguards to protect against GPS spoofing attacks. One approach to prevent GPS spoofing is assisted GPS, which uses cell tower triangulation in addition to latitude and longitude to verify a device location. A system using assisted GPS uses cell tower maps that align with latitude and longitude coordinate data. For instance, if a device is located in Chicago but falsely reports its location as Boston, the assisted GPS system would be able to tell that the cell tower used by the device was in Chicago and not Boston, as indicated by the device.

The following embodiments present technical solutions to the aforementioned technical challenges of relying on GPS coordinates to determine or verify the location of a device. In one example, location fingerprints, or templates, are created for various locations using unique combinations of select types of sensor data associated with those locations. In another example, the location fingerprints and uniquely associated sensor data are used to verify a device location. The sensor data is collected from a variety of different sensors and may include environmental attributes specific to, or that uniquely characterize, the location at which the sensor data was collected from various sensors.

### System Overview

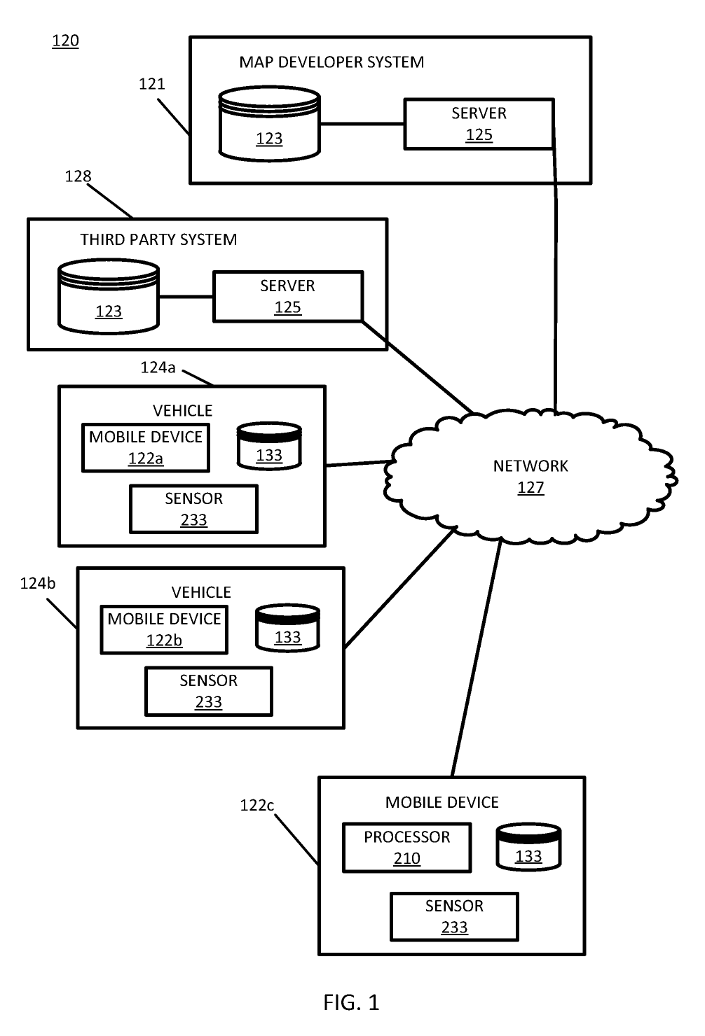

FIG. 1 illustrates an example system for location fingerprinting. In FIG. 1, one or more vehicles 124a, 124b or mobile devices 122a, 122b, 122c are connected to a server 125 in either a map developer system 121 or third party system 128 though the network 127. The vehicles 124a-b may be directly connected to the server 125 or through an associated mobile device 122a-b. Both the map developer system 121 and third party system 128, including the servers 125 and geographic or map databases 123, exchange (e.g., receive and send) data from the vehicles 124a-b and/or mobile devices 122a-c. The mobile devices 122a-c include at least one processor 210 and at least one local database 133. The at least one local database 133 may be modified according to the server 125 and may include a subset of the data of database 123. The mobile devices 122a-c may be standalone devices such as smartphones or devices integrated with vehicles. Additional, different, or fewer components may be included.

The database 123 of the map developer system 121 or third party system 128 may include sensor data from various types of sensors associated with one or more locations. The sensor data may be stored in the database 123 as an attribute or as a data layer for each of the one or more locations. The sensor data may be stored in association with various characteristics or properties, which are discussed in more detail below, including environmental attributes associated with, or characteristic of, the one or more locations. The sensor data may also be stored in association with a predefined threshold, which is discussed in more detail below, relating to the sensor data associated with the one or more locations. The sensor data, from various types of sensors, associated with a particular location and predefined threshold may also be referred to as sensor criteria, or a location fingerprint. The term “location fingerprint” includes the specific association of sensor data, types of sensors used to collect the sensor data, and predefined threshold with a particular location and may also be referred to as a location template, location profile, location record, location identification, location ID, location imprint, location characteristic, or any other similarly related term or terms.

The database 123 may include a map of road segments or road links that are connected at nodes. Each road segment may be stored in association with various characteristics or properties, which are discussed in more detail below, including road characteristic or road property. In some examples, the database 123 may be augmented according to a location associated with sensor data from various sensors to provide an attribute for the road segment or node associated with the location of where the sensor data was collected. The attribute may indicate the road curvature, elevation change along the road segment, the presence of any unique landmarks along the road segment, or other attributes.

The map developer system 121 or third party system 128 may collect the sensor data associated with one or more locations from a variety of sensors in a variety of ways. In one embodiment, the map developer system 121 or third party system 128 may collect sensor data from different types of sensors automatically, such as by crowdsourcing. The increased availability of all kinds of sensors on either vehicles or mobile devices allow for the collection of sensor data associated with various locations from a multitude of sensors and types of sensors. The vehicles 124 or mobile devices 122, described in further detail below, may include one or more onboard sensors 233 for sensing certain types of data. The sensed data may be associated with the location where it was sensed by the onboard sensor(s) 233 and may be stored in local database 133. The vehicles 124 or mobile devices 122 may collect sensor data from the onboard sensor(s) 233 and send the sensor data, including its type and its association to the location where it was sensed, to the map developer system 121 or third party system 128 automatically each time the vehicles 124 or mobile devices 122 are turned on, or continuously during the entire time the vehicles 124 or mobile devices 122 are on, or only when the vehicles 124 or mobile devices 122 are within sensing range of a desired location. Another example is that the vehicles 124 or mobile devices 122 may collect sensor data from the onboard sensor(s) 233 and send the sensor data, and associated location, to the map developer system 121 or third party system 128 automatically whenever a particular application is in use, such as a navigation system. A user of a vehicle 124 or mobile device 122 may choose whether to automatically send sensor data and associated location information collected by the onboard sensor(s) 233 by activating a feature on the vehicle 124 or mobile device 122.

In another embodiment, the vehicle 124 or mobile device 122 may automatically send sensor data and associated location information collected by the onboard sensor(s) 233 at regular intervals, such as time intervals or distance traveled intervals (e.g., every 5 minutes or every time the device moves more than 5 meters). Vehicle 124 or mobile device 122 users may also be asked to automatically provide sensor data from various sensors and associated location information whenever the vehicle 124 or mobile device 122 is in a location that currently does not have much, if any, sensor data associated with it, such as remote locations, hard to reach locations, unique locations, hidden locations, and the like. Vehicle 124 or mobile device 122 users may also be asked to automatically send sensor data and associated location information whenever certain sensor data measurements collected by the onboard sensor(s) 233 change by a certain degree, which would indicate a change in location when one location is different, or has unique geographic features, as compared to nearby locations.

In another embodiment, the map developer system 121 or third party system 128 may collect sensor data manually, by providing various types of sensors at a location where sensor data is desired. One example of this manual approach is the map developer or third party sending employees with vehicles or mobile devices to the desired location to collect multiple types of sensor data at that desired location.

In another embodiment, the map developer system 121 or third party system 128 may collect sensor data semi-automatically, by collecting some sensor data automatically, as described above, and by collecting other sensor data manually, as described above. For example, the map developer system 121 or third party system 128 may collect sensor data and associated location information from popular locations automatically from the onboard sensor(s) 233 of vehicles 124 or mobile devices 122 that are within sensing range of a desired location, and may collect sensor data from remote, hard to reach, unique, or hidden locations manually by providing sensors at those locations, such as employees with vehicles and/or mobile devices.

In one embodiment, the map developer system 121 collects sensor data simultaneously with collecting data to build a map database. The map developer system 121 may collect the sensor data along with the map database data either automatically or manually. The collected sensor data may be stored together with the map database data, or separately. The sensor data may also be associated with the map database data.

In another embodiment, the map developer system 121 or third party system 128 may collect sensor data by purchasing this data from a database developer. Sensor data may be purchased at various levels, as discussed below, where more sensor data, particularly more granular sensor data, is purchased at a higher cost than basic, less granular sensor data.

There may be a variety of databases available that provide sensor data. For instance, some database developers may have databases that provide only a certain type of sensor data, such as data from temperature sensors. As another example, some database providers may specialize in certain types of data, such as, for example, in weather related data. In that case, those database developers may offer several different types of sensor data that relate to weather, such as temperature, humidity, wind speed, atmospheric pressure, etc. In another example, a database developer may specialize in mapping applications and may have databases containing various types of sensor data relating to maps, such as road conditions, road geography, and traffic information. Different database developers may have different databases that catalog any number of different types and amount of sensor data. These database developers may offer sensor data at various levels, where higher levels of sensor data may contain more types and quantity of sensor data than lower levels. Higher levels may also contain more granular sensor data, such as more details associated with the sensor data and sensor data that is more specific.

The server 125 of either the map developer system 121 or third party system 128 is configured to access the sensor data, or sensor criteria, from the database 123. The database 123 may include a lookup table that associates sensor data with the type of sensor that data was captured by and respective locations. The lookup table may also associate a predefined threshold, which is discussed in more detail below, with the sensor data and the respective locations. The server 125 queries the lookup table with location identifiers for the sensor data and receives the sensor data and predefined threshold for the respective locations.

The server 125 of the map developer system 121 or third party system 128 may analyze or compare the sensor criteria and associated location information stored in the database 123 with sensor data and associated location information from different sensors of vehicles 124 or mobile devices 122. The server 125 may request sensor data and associated location information from one or more onboard sensor(s) 233 of vehicles 124 or mobile devices 122, each of the one or more onboard sensors 233 providing different types of sensor data. Alternatively, the server 125 may request sensor data and associated location information stored in local database 133. The server 125 is configured to determine, based on the comparison of the requested sensor data and associated location information from one or more onboard sensor(s) 233 of vehicles 124 or mobile devices 122 with the sensor data and predefined threshold associated with respective locations in database 123, whether locations match by determining whether sensor data from different types of sensors associated with locations match. The server 125 may also analyze a predefined threshold stored in database 123, which is associated with the sensor data stored in database 123, to make the above determination. For instance, the server 125 may determine that a vehicle or mobile device location is verified if the server 125 determines that the sensor data received from the vehicle or mobile device meets or exceeds the predefined threshold of the sensor criteria stored in database 123 for the location at which the vehicle or mobile device is reported to be.

Once the server 125 has determined whether the requested sensor data and associated location information from one or more onboard sensor(s) 233 of vehicles 124 or mobile devices 122 matches the sensor data and predefined threshold associated with respective locations in database 123, the server 125 may communicate the result, such as whether a location is verified, to the vehicles 124 or mobile devices 122 from which the requested sensor data was received. The server 125 may also communicate the verification result to a map developer, third party, or any other service or service provider. The server 125 may generate a message as a means for communicating the verification result to the vehicles 124, mobile devices 122, map developer, third party, or other services or service providers. The generated message may contain, in addition to the result of the verification, what sensor data was compared to make such verification determination, such as the requested sensor data from one or more onboard sensor(s) 233 of vehicles 124 or mobile devices 122 and the sensor data and predefined threshold accessed from database 123, location information associated with this sensor data, and the time at which the verification determination was made. The generated message may also contain data indicative of which device, such as vehicle 124 or mobile device 122, or which service provider initiated the verification process and the devices or service providers that are receiving the verification result.

The server 125, in response to the determination described above, may also indicate the result of the determination in the database 123, such as by adding a data layer or attribute, or any other data storage method. Depending on the result of the determination, the server 125 may also enable or disable one or more functions, such as an application, of the map developer system 121 or third party system 128.

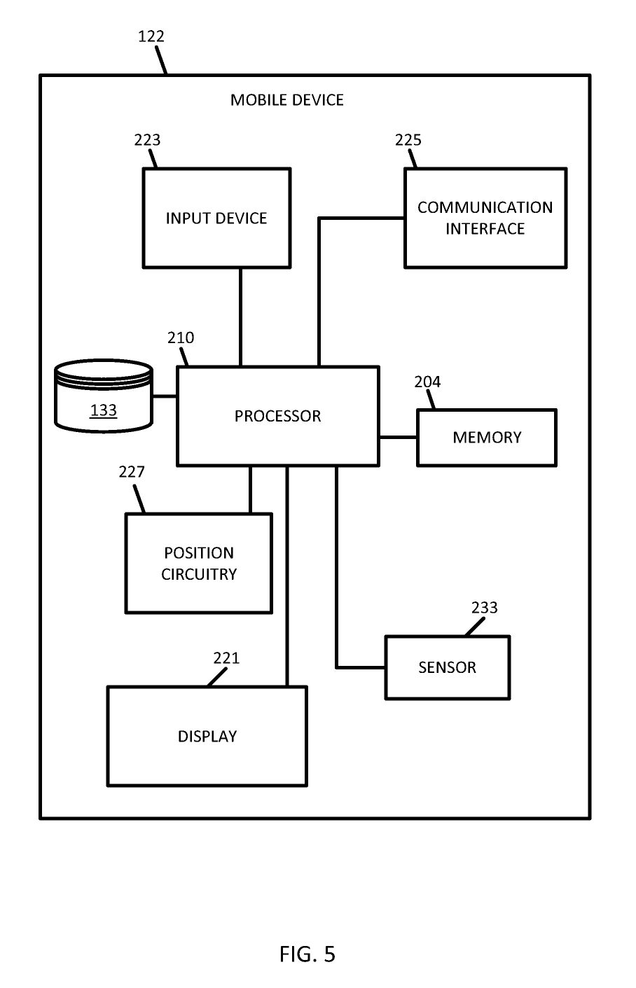

In another embodiment, the vehicle 124 or mobile device 122 may perform self-authentication or self-verification by analyzing and comparing sensor criteria and associated location information stored in the database 123 with sensor data and associated location information from one or more onboard sensor(s) 233. In this embodiment, the vehicle 124 or mobile device 122 may communicate with database 123 via the network 127 and server 125 to receive the stored sensor criteria and associated location information from database 123. The vehicle 124 or mobile device 122 may then compare the stored sensor criteria and associated location information for a given location with sensor data collected from the onboard sensor(s) 233 at that given location. The vehicle 124 or mobile device 122 authenticates itself or verifies its location when the two sets of sensor data match for the given location. The result of this verification may be communicated to a user or an application of the vehicle 124 or mobile device 122, or to a third party. The communication may be in the form of a verification message and may include, in addition to the result of the verification, what sensor data was compared to make such verification determination, location information associated with the sensor data, and the time at which the verification determination was made. The verification message may also contain data indicative of which device, such as vehicle 124 or mobile device 122, or which service provider initiated the verification process and the devices or service providers that are receiving the verification message. The vehicle 124 or mobile device 122 may also limit functionality of the vehicle 124 or mobile device 122, or applications running thereon, in response to whether the vehicle 124 or mobile device 122 location is verified. This embodiment of vehicles 124 or mobile devices 122 self-authenticating or self-verifying location for autonomous vehicles, is described in more detail below in reference to the mobile device 122 of FIG. 5.

### Exemplary Vehicle

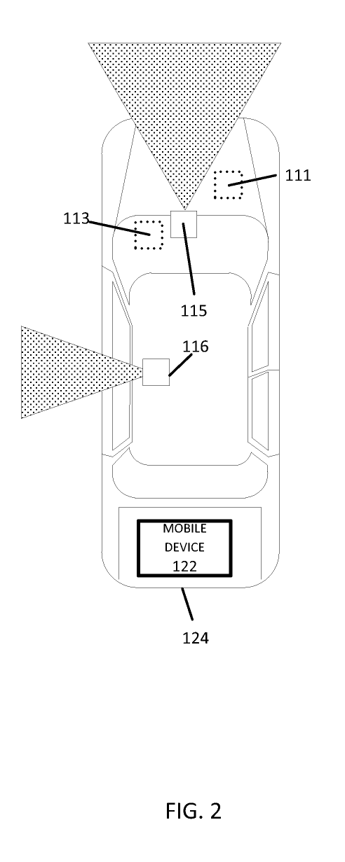

FIG. 2 illustrates an example vehicle 124 of the system described above in FIG. 1. The vehicle 124 may be used for collecting sensor data for various locations using various sensors. As described above, the collection of sensor data via the vehicle 124 may be done automatically, manually, or semi-automatically. A connected vehicle 124 includes a communication device and an environment sensor array for reporting the surroundings of the vehicle 124 to the server 125. The vehicle 124 may report sensor data collected from the sensor array to the server 125 automatically, as discussed above, or in response to a request from the server 125. The reported sensor data may be sent to the server 125 in a manner that associates the sensor data with the location from where the sensor data was collected. The connected vehicle 124 may include an integrated communication device coupled with an in-dash navigation system. The in-dash navigation system may provide the location related information to be reported to the server 125 in association with the reported sensor data.

The connected vehicle 124 may include an ad-hoc communication device such as a mobile device 122 or smartphone in communication with a vehicle system. The communication device connects the vehicle 124 to a network including at least one other vehicle 124 and at least one server 125. The network may be the Internet or connected to the internet. The sensor data collected from the sensor array may also be sent to the server 125 in association with location information provided by either the communication device or the network. The vehicle 124 may report to the server 125 sensor data from all available sensors on the vehicle 124. Alternatively or additionally, the vehicle 124 may report to the server 125 sensor data from only a subset of sensors from the set of sensors in the sensor array. The determination of what sensor data, and from which sensors, the vehicle 124 reports to the server 125 may be automatically determined or may be determined in response to a particular request from the server 125. The sensor data may also be stored locally on the vehicle 124, such as in a memory of the communication device or in-dash navigation system, and may be reported to the server 125 at a later time, such as when the vehicle 124 is no longer at the location at which it collected the sensor data.

The sensor array may include one or more sensors configured to detect surroundings of the vehicle 124. The sensor array may include multiple sensors. Example sensors include an optical distance system such as a light detection and ranging (LiDAR) system 116, an image capture system 115 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera. The LiDAR system 116 and image capture system 115 may collect any sensor data that describes the environment surrounding the vehicle 124, such as whether the vehicle 124 is traveling in a tunnel, whether the sun is shining, whether the current weather includes precipitation, or other factors external to the vehicle 124. The vehicle 124 is not limited to only the LiDAR system 116 and image capture system 115 described above and may include any sensors now known and currently available, or to be available, on the market, or to be developed in the future. Other examples of environmental attributes that the sensor array may collect include temperature, altitude or elevation, lighting, sound or noise level, humidity, atmospheric pressure, wind speed, and the presence of magnetic fields or electromagnetic interference. Any attribute that may be sensed may be collected by the sensor array. In another example, cell tower and wi-fi information, such as available cell tower and wi-fi access points, may also be collected by the sensor array of the vehicle 124. In yet a further example, the sensor array may collect information pertaining to the specific approach the vehicle used to travel to a specific location.

The vehicles 124 may include a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer built or embedded into or within the interior of the mobile device 122.

### Location Fingerprint

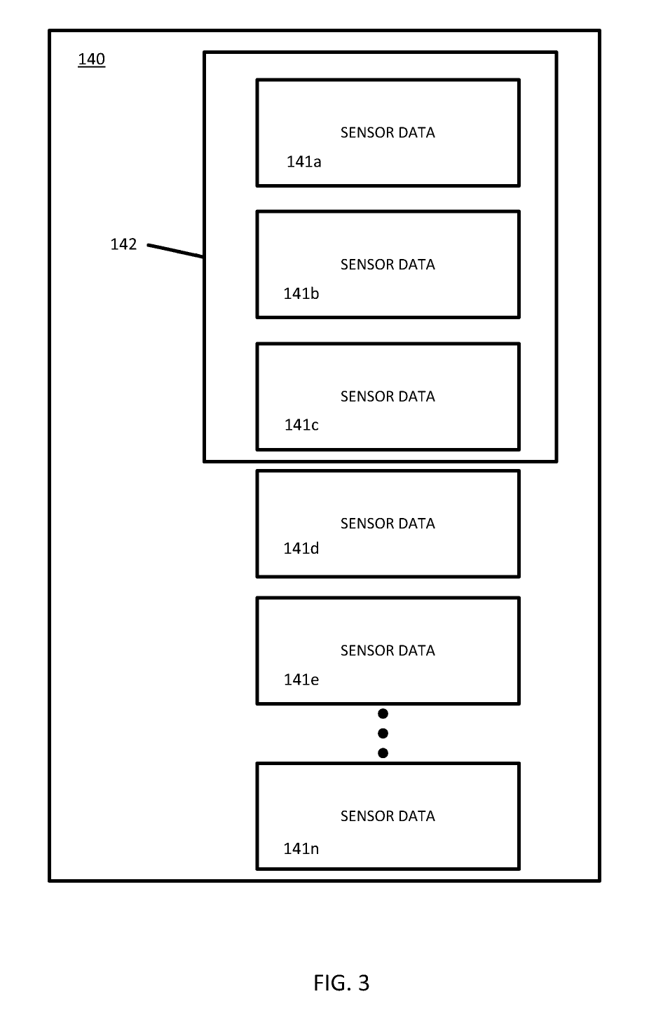

FIG. 3 illustrates an example location fingerprint 142 associated with a particular location 140. In this embodiment, a plurality of sensor data 141a-n is associated with location 140. The plurality of sensor data 141a-n may include any number of different types of sensor data. In one example, sensor data 141a may contain data indicative of the temperature at location 140, sensor data 141b may contain data indicative of the elevation of location 140, sensor data 141c may contain data indicative of the ambient lighting at location 140, sensor data 141d may contain data indicative of the wind speed at location 140, and sensor data 141e may contain data indicative of any electromagnetic interference at location 140. The plurality of sensor data 141a-n may contain data indicative of any attribute of location 140 able to be sensed by any device sensor now known or later developed. Other examples of sensor data, or attributes, that may be attributable to a location may include sound or noise level, humidity, atmospheric pressure, and the presence of radio- or micro-waves. Any attribute that may be sensed may be included as sensor data. In another example, cell tower and wi-fi information, such as available cell tower and wi-fi access points, may also be included in sensor data as attributes of a location. In yet a further example, the sensor data may include information pertaining to the specific approach the device, such as a mobile device or vehicle, used to travel to a specific location.

In another example, the sensor data 141a-n may contain data that identifies a particular type of sensor to ping, or query, to request additional sensor data from. For example, sensor data 141a may identify a temperature sensor to ping in order to receive temperature data, sensor data 141b may identify an altitude sensor to ping in order to receive elevation data, sensor data 141c may identify a lighting sensor to ping in order to receive lighting data, sensor data 141d may identify a wind speed sensor to ping in order to receive wind speed data, and sensor data 141e may identify an electromagnetic sensor to ping in order to receive electromagnetic interference data.

The sensor data 141a-n may be collected in any way, such as those described above with reference to FIGS. 1 and 2.

A location fingerprint 142 is predefined, as discussed below, and may include a collection of a set of sensor data from a plurality of sensor data 141a-n associated with a particular location 140. As discussed above, the sensor data may contain attributes of location 140 able to be sensed or may identify a particular type of sensor to ping at location 140. The set of sensor data associated with the location 140 to be included in the location fingerprint 142 may vary. For example, the set of sensor data to be included in a location fingerprint may include only one attribute, or type of sensor data, or may only identify one sensor to ping. In another example, the set of sensor data to be included in a location fingerprint may include five attributes, or types of sensor data, or may identify five sensors to ping. The only limit to the number of types of sensor data that may be included in a location fingerprint is the number of types of sensors available to sense data. The location fingerprint 142 of FIG. 3, for example, includes a set of three different types of sensor data 141a-c associated with location 140. As described above, this set of three types of sensor data 141a-c contains either data indicative of the temperature at location 140, the elevation of location 140, and the ambient lighting at location 140, or data identifying a temperature sensor, altitude sensor, and lighting sensor to ping at location 140.

The number of attributes or types of sensors to ping that are associated with a particular location in a location fingerprint may vary depending on the location or how the location fingerprint is used, both of which are described in more detail below. For instance, the greater number of attributes or types of sensors to ping that are associated with a particular location may be indicative of importance, popularity, or potential for security or safety risks. The availability of sensor data at a location may also limit the amount or type of sensor data used for a location fingerprint. For example, in a very remote location where sensors are rarely available to collect sensor data, the amount or type of sensor data associated with that remote location may be limited. In some cases, a location may not qualify to be associated with a location fingerprint. For instance, a location may not have enough, or any, sensor data available to associate with it.

A location fingerprint 142 may also include at least one threshold relating to the set of sensor data 141a-c included in the location fingerprint 142. The at least one threshold may include a predefined value or range of values for the set of sensor data 141a-c associated with the location 140. For example, one threshold may be a temperature threshold that includes a limit for an external temperature value of at least 42 degrees Fahrenheit, or an internal temperature value of at least 68 degrees Fahrenheit. In this example, the temperature threshold may alternatively indicate that the temperature value must be within 10 degrees of 42 degrees Fahrenheit for an external temperature and within 2 degrees of 68 degrees Fahrenheit for an internal temperature. In another example, a threshold may be an elevation threshold that includes a minimum elevation value that must be satisfied, such as, for example, at least 700 feet above sea level. In yet another example, a threshold may be a lighting threshold that includes a minimum value for ambient lighting, or illuminance, of 1,000 LUX. Alternatively, the lighting threshold may include a range of values as a limit, such as between 9,000 and 10,000 LUX.

The at least one threshold may also include a predefined amount of sensor data associated with the location 140. In one example, a threshold may include a requirement of at least three sets of sensor data, or attributes, from a plurality of sensor data, or attributes, associated with a particular location. In another example, a threshold may require at least five sets of attributes, or sensor data, associated with a location. It may be desirable to have varying levels of thresholds. For instance, predefining a threshold requiring a higher number or amount of sensor data may indicate that the location associated with that threshold is of higher importance, or may pose a higher security or safety risk.

The at least one threshold may also include a predefined type of sensor data associated with the location 140. For example, the threshold relating to the type of attribute, or sensor data, may require sensor data from temperature sensors and lighting sensors. In another example, the threshold relating to the type of attribute, or sensor data, may require sensor data from only elevation sensors. The threshold relating to the type of sensor data may contain any number of different types of sensor data.

The at least one threshold may also include a combination of requirements, such as those described above. For example, a threshold may include a predefined number and a predefined type of sensor data associated with the purported location. In this example, the threshold may require at least three sets of sensor data from at least temperature sensors, elevation sensors, and lighting sensors. The at least one threshold may also include other requirements pertaining to the sensor data.

Two additional example location fingerprints, or templates, are shown below in Table 1. The first example in Table 1 is for a stadium located within a city and the second example in Table 1 is for a viewing deck of a skyscraper. Both examples include at least elevation data, temperature data, and lighting data.

TABLE 1
Location Fingerprint Examples

```
Location FingerPrint 1 Example
  Location: City Stadium
  Identification:
    Lat/Long: XXX/YYY
    Elevation: ZZZ
      Elevation Profile
        Approach Profile: Flat @ 700FT
        Location Profile: 36″ Vertical elevation possible,
        12″ increments at locations: X (elevator,
        90 degreevertical climb), and Y (Escalator, 45degree climb)
      Approach Profile
        Vehicular Approach pattern: 100″ Entrances S, W, E, N & NW
        Pedestrian approach pattern:
          Expected 100″ Entrances S, W, E, N & NW
          Possibie: Any
    Current Ambient temp:
      External 42F.
      Internal: 68F.
    Current Ambient Lighting: 1,000 LUX
    <Insert additional geospatial or environmental data>
Location FingerPrint 2 Example
  Location: SkyScraper viewing deck
  Identification:
    Lat/Long: XXX/YYY
    Elevation: ZZZ
      Elevation Profile
        Approach Profile: 900FT 90degree vertical climb
        Location Profile: Flat within 120 FT all directions
        Vehicular: None
        Pedestrian:
          Expected: 100 Foot any direction at elevation X,
          followed by 900ft climb
    Current Ambient temp:
      External 42F.
      Internal: 68F.
    Current Ambient Lighting: 10,000 LUX
    <Insert additional geospatial or environmental data>
```

In the embodiment of FIG. 3, the predefined threshold is associated with the set of sensor data 141a-c. The set of sensor data 141a-c associated with a particular location 140 and the predefined threshold associated with the set of sensor data 141a-c may also be referred to as sensor criteria. Sensor criteria forms the basis of the location fingerprint 142.

The location fingerprint 142, including the set of sensor data 141a-c associated with a particular location 140 and the predefined threshold associated with the set of sensor data 141a-c may be stored in the database 123 of either the map developer system 121, the third party system 128, or some other system. The location fingerprint 142 may also be stored on a local database 133 of vehicles 124 or mobile devices 122. The location fingerprint 142 may be stored as a data attribute or as a data layer. The location fingerprint 142 may also be stored in other data structure configurations known to those of ordinary skill in the art.

The term “location fingerprint” includes the specific association of sensor data, types of sensors used to collect the sensor data, and predefined threshold with a particular location and may also be referred to as a location template, location profile, location record, location identification, location ID, location imprint, location characteristic, or any other similarly related term or terms.

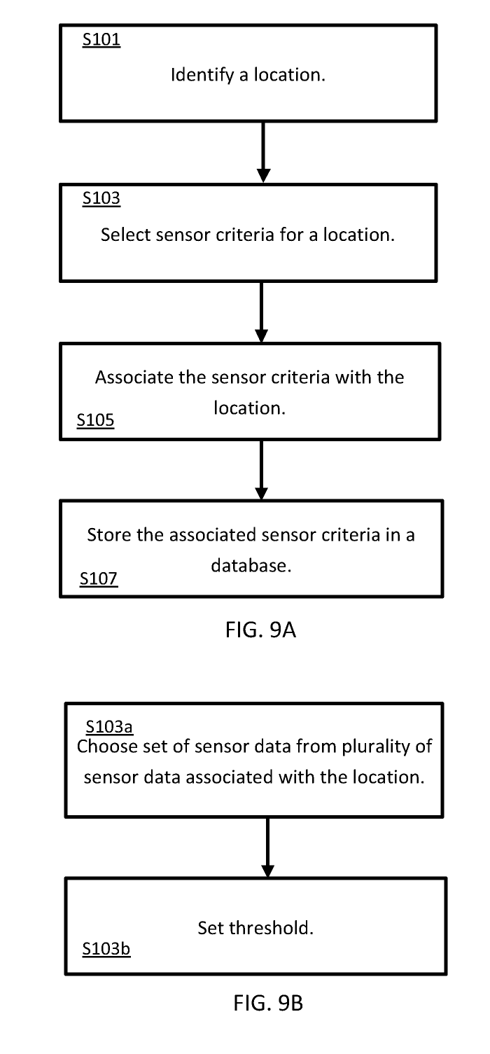

A description of creating a location fingerprint 142 is described below with reference to FIGS. 9A and 9B.

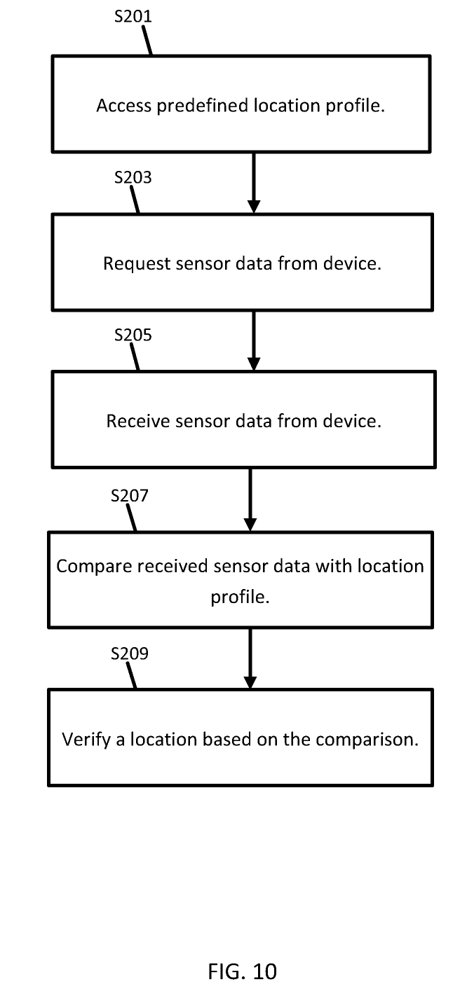

A description of using a location fingerprint 142 to verify a location of a device is described below with reference to FIG. 10.

### Example Fingerprint Locations

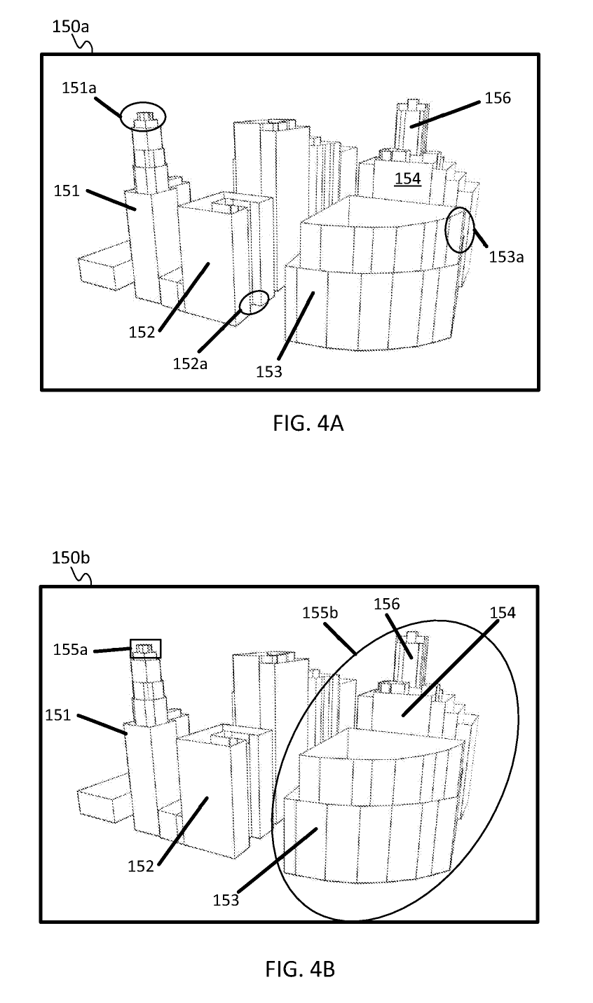

FIGS. 4A and 4B illustrate example locations used for location fingerprinting. The three-dimensional map 150a of FIG. 4A includes buildings 151, 152, 153, 154, and 156. In an urban area such as that depicted in the three-dimensional map 150a of FIG. 4A, relying on GPS alone to determine or verify a location of a device may be problematic, since urban areas are particularly prone to GPS signal error since the tall buildings, the many reflective surfaces, and the presence of interfering frequencies, such as electromagnetic frequencies or radio signals, may affect the GPS signal strength, as described above. Using the specific approaches relating to location fingerprints described herein to determine or verify a device location provides a solution to these types of problems with GPS systems and offers an improvement in location tracking technology. One example benefit of using location fingerprints in areas such as that shown in FIG. 4A include improved accuracy for determining a location of a device.

As described above, a location fingerprint is predefined and may include a collection of a set of sensor data from a plurality of sensor data associated with a particular location. As discussed above, the sensor data may contain attributes of the particular location able to be sensed or may identify particular types of sensor to ping at a location. With reference to FIG. 4A, example locations associated with location fingerprints are shown as locations 151a, 152a, and 153a. Location 151a may be a viewing deck at the top of a skyscraper 151. Location 152a may be street level lobby of building 152. Location 153a may be an unobstructed mid-level corner office of building 153.

Each of locations 151a, 152a, 153a may be associated with either their own set of sensor data, or attributes, from a plurality of sensor data, or types of sensors that are indicative of their respective locations. The respective set of sensor data for each of locations 151a, 152a, 153a may be collected from any means described above. For example, sensor data for each of locations 151a, 152a, 153a may be collected from onboard sensor(s) 233 of mobile devices 122. As described above, sensor data for each of locations 151a, 152a, 153a may be collected automatically from onboard sensor(s) 233 of a mobile device 122 whenever the mobile device 122 is within sensing range of the locations 151a, 152a, 153a. Alternatively, sensor data for each of locations 151a, 152a, 153a may be collected manually by sending at least one person with a mobile device 122 to each of locations 151a, 152a, 153a.

In one example, the set of sensor data associated with location 151a may include data indicative of temperature, elevation, and wind speed, since each of these attributes are very characteristic of a viewing deck at the top of a skyscraper. For instance, the temperature at the top of a skyscraper tends to be significantly cooler than the temperature at street level, such as location 152a. Similarly, the elevation of a viewing deck at the top of a skyscraper is also very characteristic of its location, especially as compared to surrounding locations, such as street level location 152a. Likewise, wind speed at the top of a skyscraper is indicative of its location as compared to location 152a, which may be protected from the wind by surrounding buildings. Alternatively, the set of sensor data associated with location 151a is not limited to these examples and may include more sensor data or less sensor data. The set of sensor data associated with location 151a may also contain data that identifies the types of sensors to ping, or query, at that location. In this example, the set of sensor data associated with location 151a may identify a temperature sensor, altitude sensor, and wind speed sensor to ping in order to receive temperature data, elevation data, and wind speed data.

In another example, the set of sensor data associated with location 152a may include data indicative of at least elevation and lighting. Elevation may be characteristic of location 152a given that it is at street level in an urban location with many tall buildings surrounding it. Lighting may also be very indicative of location 152a given that the tall buildings surrounding this location, such as buildings 152 and 153, may block sunlight and keep location 152a shaded for most of the day. Alternatively, the set of sensor data associated with location 152a is not limited to these examples and may include more sensor data or less sensor data. The set of sensor data associated with location 152a may also contain data that identifies the types of sensors to ping, or query, at that location. In this example, the set of sensor data associated with location 152a may identify an altitude sensor and a lighting sensor to ping in order to receive elevation and lighting data.

In yet another example, the set of sensor data associated with location 153a may include data indicative of at least lighting and sound. For instance, building 153 may be located at the corner of a block and directly adjacent to a park, which provides location 153a with unobstructed views and thus more direct sunlight. For this reason, sensor data indicative of lighting is used for the location fingerprint at location 153a. Likewise, given that location 153a is directly adjacent a park as opposed to other buildings and heavy street traffic, there is a reasonable chance that location 153a is more quiet than surrounding locations. Thus, sound data would be characteristic of location 153a. Alternatively, the set of sensor data associated with location 153a is not limited to these examples and may include more sensor data or less sensor data. The set of sensor data associated with location 153a may also contain data that identifies the types of sensors to ping, or query, at that location. In this example, the set of sensor data associated with location 153a may identify a lighting sensor and a sound sensor to ping in order to receive lighting and sound data.

In another example, the set of sensor data associated with a location under a bridge, or on the lower level of a multilevel street, such as Wacker Drive in Chicago, Ill., may include data indicative of at least lighting and elevation or may identify a lighting sensor and altitude sensor to ping, since sensor data for elevation and lighting under the bridge or on the lower level of the multilevel street would be different than sensor data for elevation and lighting on the bridge or on the upper level of the multilevel street.

In another example, the set of sensor data associated with a location on a beach or near a body of water, such as Lake Michigan in Chicago, Ill., may include data indicative of at least lighting, elevation, wind speed and humidity, or may identify a lighting sensor, altitude sensor, wind speed sensor, and humidity sensor to ping. Lighting data may be indicative of this location since a beach is normally in direct sunlight all day. Elevation data may be indicative of this location since a beach is normally at a lower elevation. Wind speed data may be indicative of this location since there may not be any structures near the beach to block the wind. Humidity data may be indicative of this location since a beach may be more humid than other locations given the proximity of the beach to water.

The number of location fingerprints in any given area is not limited. For example, there may be one location fingerprint associated with building 151 or there may be several location fingerprints associated with building 151. In another example, as will be described in more detail below, a location fingerprint may include sensor data associated with an entire building or more than one building.

FIG. 4B illustrates another embodiment of locations used for location fingerprinting. The three-dimensional map 150b of FIG. 4B includes buildings 151, 152, 153, 154, and 156. As described above, a location fingerprint is predefined and may include a collection of a set of sensor data from a plurality of sensor data associated with a particular location. As discussed above, the sensor data may contain attributes of the particular location able to be sensed or may identify particular types of sensor to ping at a location. The location associated with a location fingerprint may be a point of interest, or a single point in space, such as a point represented by an exact latitude and longitude coordinate. The location associated with a location fingerprint may also be a predefined area. The predefined area may be configured to include, for example, a building, a portion of a building (such as the viewing deck of a skyscraper), or an entire mall. For example, a location fingerprint may be associated with the Willis (formerly Sears) Tower in Chicago, Ill. In another example, a location fingerprint may be associated with the Skydeck of the Willis Tower. In yet another example, a location fingerprint may be associated with the Mall of America in Bloomington, Minn.

With reference to FIG. 4B, example predefined areas 155a, 155b used as locations associated with location fingerprints are shown. In this embodiment, predefined area 155a may be the entire top floor, or viewing deck, of building 151. Predefined area 155b may encompass all of buildings 153, 154, and 156, as well as the space immediately surrounding buildings 153, 154, and 156.

Sensor data used in a location fingerprint that is associated with a predefined area may include a set of sensor data indicative of the entire predefined area or may include a set of sensor data for particular points within the predefined area. Similarly, a predefined threshold associated with a set of sensor data for a predefined area may be associated with sensor data indicative of the entire predefined area or may be associated with sensor data for particular points within the predefined area. The set of sensor data associated with a predefined area and the predefined threshold associated with the set of sensor data for the predefined area may also be referred to as sensor criteria.

### Exemplary Mobile Device

FIG. 5 illustrates an exemplary mobile device 122 of the system of FIG. 1. The mobile device 122 includes a processor 210, a local database 133, a memory 204, an input device 223, a communication interface 225, position circuitry 227, a display 221, and one or more sensors 233. The input device 223 may receive settings or instructions to select one or more sensors 233 contained therein and whether, and when, to collect data from the one or more sensor 233. The input device 223 may also receive settings or instructions regarding whether, and when, to send the collected sensor data from the one or more sensors 233 to another device or system. The input device 223 may receive data from other devices or systems, such as sensor criteria or location fingerprints. Additional, different, or fewer components are possible for the mobile device 122.

The position circuitry 227 or the processor 210 may detect a geographic position of the mobile device 122, or the vehicle 124 if the mobile device 122 in integrated into a vehicle 124, and may send the geographic location for the mobile device 122 to a server. The position circuitry 227 is one example means for detecting or determining a geographic position. The processor 210 also includes circuitry serving as means for detecting or determining a geographic position. The detected geographic position of the mobile device 122 may include a latitude and longitude pair. The geographic position may be detected or sampled at periodic intervals in time or distance. The sensor 233, which may include distancing sensors, range sensor, image sensors, or another sensor as described above may also provide information for determining the geographic position of the mobile device 122.

The processor 210 or the communication interface 225 may also receive settings or instructions to select one or more sensors 233 contained therein and whether, and when, to collect data from the one or more sensor 233. The processor 210 or the communication interface 225 may also receive settings or instructions regarding whether, and when, to send the collected sensor data from the one or more sensors 233 to another device or system. The selection, if manual, may be made by a display 221 or input device 223 or opening a mobile application (i.e., attempting to use a mobile application), or by making selections from a menu. The communication interface 225 is an example for a means for receiving data indicative of the manual sensor selection, including what sensors to collect data from and whether, and when, to send that data to another device or system. The display 221 or input device 223 are examples of means for receiving the manual selection of the one or more sensors. For automatic selection of sensors, the processor 210 may include circuitry or a module or an application specific controller as a means for receiving the data indicative of the sensor selection, including what sensors to collect data from and whether, and when, to send that data to another device or system.

The display 221 or input device 223 of the mobile device 122 may notify the user of their selections or of the status of the location verification process described below. The display 221 or input device 223 of the mobile device 122 may also display sensor data, or attributes, associated with locations, as well as sensor criteria, including one or more predefined thresholds associated with certain sensor data.

In one example, the location of the mobile device 122 may be self-authenticated or self-verified, either manually or automatically, by analyzing and comparing sensor criteria and associated location information stored in a database 123 with sensor data and associated location information from one or more onboard sensor(s) 233. In this embodiment, the mobile device 122 may communicate with database 123 via the network 127 and server 125. The communication may be made manually by a display 221 or input device 223 or opening a mobile application (i.e., attempting to use a mobile application), or by making selections from a menu. The communication interface 225 is an example for a means for manually or automatically communicating with another device or system. Alternatively, the communication with the database 123 and server 125 may be performed automatically by the processor 210, including circuitry or a module or a communication specific application contained within the processor 210 or memory 204. The processor 210, including any circuitry, modules or applications, may act as a means for automatically communicating with other devices and systems. Once communication is established with database 123 and server 125, the mobile device 122 may receive stored sensor criteria and associated location information from database 123 for the location of the mobile device 122. The mobile device may store the sensor criteria and associated location information in the memory 204.

The mobile device 122 may collect sensor data from one or more onboard sensors 233 at the mobile device 122 location. The processor 210 may associate this collected sensor data with position data relating to the current location of the mobile device 122 received from the position circuitry 227. The processor 210 may then compare the sensor criteria and associated location information received from database 123 for its current location with the sensor data collected from the onboard sensor(s) 233 at its current location. The mobile device 122 authenticates itself or verifies its location when the two sets of sensor data match for its current location.

The mobile device 122 may communicate, via the communication interface 225, the result of its self-authorization or self-verification to a user or application of the mobile device 122 or other devices and systems. The mobile device 122 may display this result on the display 221 or input device 223, or by opening a mobile application. The mobile device 122 may generate a message as a means for communicating the self-authorization or self-verification result. The generated message may contain, in addition to the result of the self-authorization or self-verification, what sensor data was compared to make such self-authorization or self-verification determination, location information associated with the sensor data, and the time at which the self-authorization or self-verification determination was made. The generated message may also contain data indicative of which device, such as vehicle 124 or mobile device 122, initiated the self-authorization or self-verification process and the devices or service providers that are receiving the generated message.

In addition, the mobile device 122 may also limit functionality of the mobile device 122, or applications running thereon, in response to whether the mobile device 122 self-authorized or self-verified.

In another example, the mobile device 122 may receive instructions to collect sensor data from a specified location. The mobile device 122 may generate a routing instruction to the specified location based on the vehicle database 133. The routing instructions may be provided by display 221. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile device 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system, or modify a current route through a road system in response to multiple requests for sensor data at more than one specified locations. For example, when the mobile device 122 determines that there are two or more alternatives for the optimum route of reaching the multiple specified locations and one of the routes passes a majority of the specified locations, the mobile device 122 selects the alternative that passes the majority of the specified locations. The mobile devices 122 may compare the optimal route to the closest route that passes the majority of the specified locations. In response, the mobile device 122 may modify the optimal route.

The mobile device 122 may include various types of communication interfaces or communication with the network 127 as the communication network characteristic. The types may include cellular devices (e.g., 3G, 4G, 4G-LTE, 5G or later developed mobile standards), wireless fidelity devices (e.g., IEEE 802.11 family of standards), or another type of device. The mobile device 122 may be configured with access technologies such as WiMAX, 3rd Generation Partnership Project (3GPP) standards, 3GPP2 and WLAN based access architectures. The types of communication may be telephonic, text message, instant message, short message service, or mobile application communication. The 5G may include Edge Computing, which allows very low latency communication, as processing is done at the “edge” of the network, e.g. at the access point. This would allow for data at the mobile device 122 to be collected and distributed quickly among participants in the vicinity of the access point. Vehicles in autonomous mode may communicate with other vehicles nearby through this mechanism.

### Exemplary Server

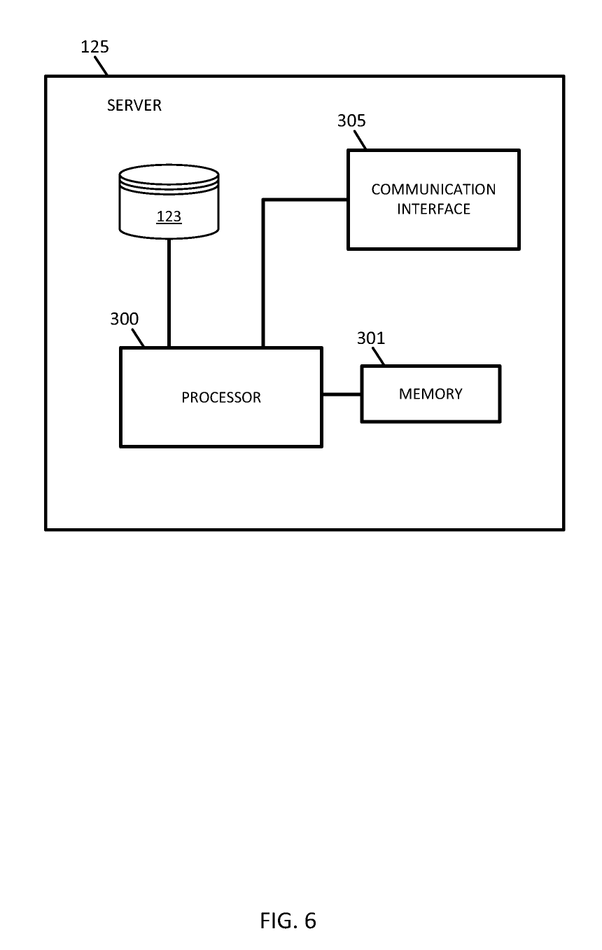

FIG. 6 illustrates an example server 125, which may apply to either the map developer system or third party system of FIG. 1. The server 125 includes a processor 300, a communication interface 305, a memory 301, and a database 123. An input device (e.g., keyboard or personal computer) may be used to enter settings to the server 125. Additional, different, or fewer components may be provided in the server 125. Alternatively, the server 125, or server component, tasked with location fingerprinting may also be implemented onboard a vehicle 124 or mobile device 122, and may rely on offline databases or online information sources.

### Exemplary Databases

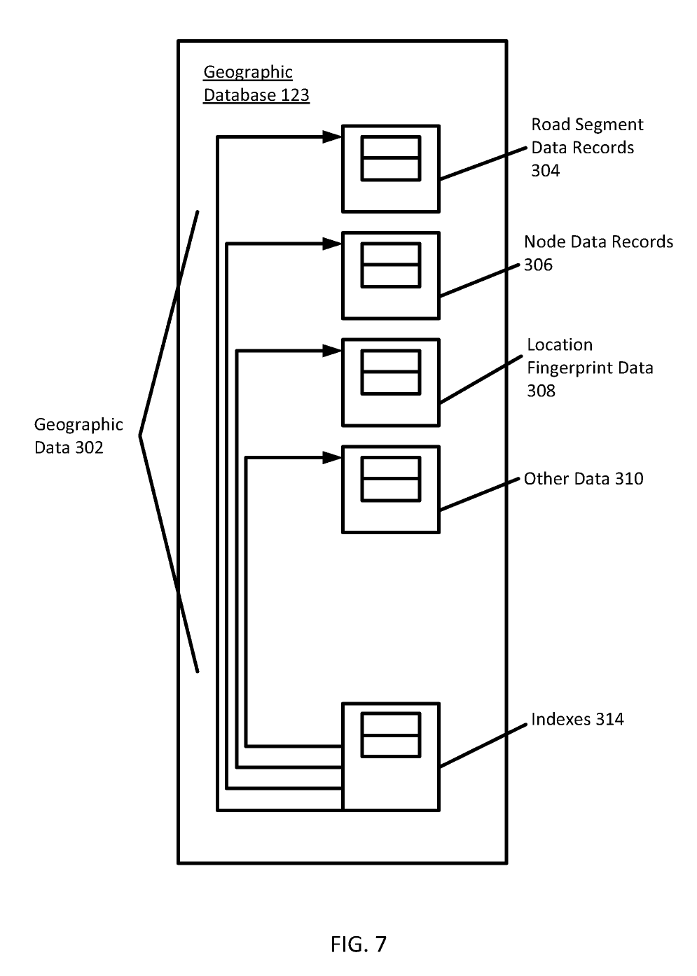

FIG. 7 illustrates an example geographic database 123 of FIG. 1 containing geographic data 302. The data 302 contained in the geographic database 123 may include data used for traffic and/or navigation-related applications. The geographic data 302 may include data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data 302. The geographic data 302 may include structured cartographic data or pedestrian routes.

In FIG. 7, the geographic database 123 may contain at least one road segment database record 304 (also referred to as “entity” or “entry”) for each road segment in a particular geographic region. The geographic database 123 may also include a node database record 306 (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

The geographic database 123 may include other kinds of data 310. The other kinds of data 310 may represent other kinds of geographic features or anything else. The other kinds of data may include point of interest (POI) data. For example, the POI data may include POI records comprising a type (e.g., the type of POI, such as restaurant, hotel, city hall, police station, historical marker, ATM, golf course, etc.), location of the POI, a phone number, hours of operation, etc.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304. As another example, the indexes 314 may relate location fingerprint data 308 with a road segment in the segment data records 304 or a geographic coordinate. An index 314 may, for example, store data relating to one or more locations and related location fingerprint data 308 for each location.

The geographic database 123 may also include other attributes of or about roads such as, for example, geographic coordinates, physical geographic features (e.g., lakes, rivers, railroads, municipalities, etc.) street names, address ranges, speed limits, turn restrictions at intersections, and/or other navigation related attributes (e.g., one or more of the road segments is part of a highway or toll way, the location of stop signs and/or stoplights along the road segments), as well as POIs, such as gasoline stations, hotels, restaurants, museums, stadiums, offices, automobile dealerships, auto repair shops, buildings, stores, parks, municipal facilities, other businesses, etc. The geographic database 123 may also contain one or more node data record(s) 306 which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data 302 may additionally or alternatively include other data records such as, for example, POI data records, topographical data records, cartographic data records, routing data, and maneuver data. Other contents of the database 123 relevant for this invention are: temperature, altitude or elevation, lighting, sound or noise level, humidity, atmospheric pressure, wind speed, the presence of magnetic fields, electromagnetic interference, or radio- and micro-waves, cell tower and wi-fi information, such as available cell tower and wi-fi access points, and attributes pertaining to specific approaches to a specific location.

The geographic database 123 may include historical traffic speed data for one or more road segments. The geographic database 123 may also include traffic attributes for one or more road segments. A traffic attribute may indicate that a road segment has a high probability of traffic congestion.

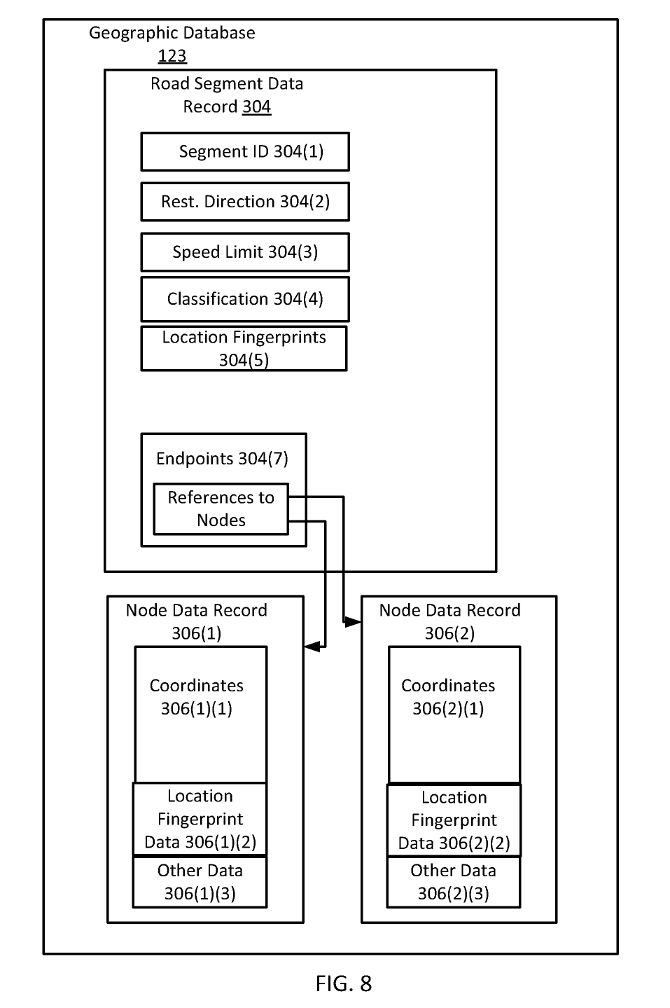

FIG. 8 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with it information (such as “attributes”, “fields”, etc.) that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include classification data 304(4) indicating whether the represented road segment is part of a controlled access road (such as an expressway), a ramp to a controlled access road, a bridge, a tunnel, a toll road, a ferry, and so on. The road segment data record may include location fingerprint data, for example a set of sensor data for a particular location.

The geographic database 123 may include road segment data records 304 (or data entities) that describe features such as location fingerprints 304(5). The location fingerprint data may be stored as a field or record using a scale of values such as from 1 to 100 (1 being a low level location fingerprint, 100 being a high level location fingerprint). The location fingerprint data may be stored using categories such as low, medium, or high. Additional schema may be used to describe the location fingerprint data. The attribute data may be stored in relation to a link/segment 304, a node 306, a strand of links, a location fingerprint, an area, or a region. The geographic database 123 may store information or settings for display preferences. The geographic database 123 may be coupled to a display. The display may be configured to display the roadway network and data entities using different colors or schemes. The geographic database 123 may provide different display information relating to where open parking spots may exist, for example.

The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment.

The road segment data record 304 may also include or be associated with other data 304(7) that refer to various other attributes of the represented road segment. The various attributes associated with a road segment may be included in a single road segment record, or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is identified, the street address ranges along the represented road segment, and so on.

FIG. 8 also shows some of the components of a node data record 306 that may be contained in the geographic database 123. Each of the node data records 306 may have associated information (such as “attributes”, “fields”, etc.) that allows identification of the road segment(s) that connect to it and/or its geographic position (e.g., its latitude and longitude coordinates). For the embodiment shown in FIG. 8, the node data records 306(1) and 306(2) include the latitude and longitude coordinates 306(1)(1) and 306(2)(1) for their node, and location fingerprint data 306 (1)(2) and 306(2)(2). The node data records 306(1) and 306(2) may also include other data 306(1)(3) and 306(2)(3) that refer to various other attributes of the nodes.

The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout a geographic region to observe features and/or record information about the roadway. Remote sensing, such as aerial or satellite photography, may be used. The database 123 is connected to the server 125.

The geographic database 123 and the data stored within the geographic database 123 may be licensed or delivered on-demand. Other navigational services or traffic server providers may access the location fingerprint data, traffic data and/or the predicted parking availability data stored in the geographic database 123. Data including the location fingerprint data or predicted parking availability data may be broadcast as a service.

### Creating Location Fingerprints

FIGS. 9A and 9B illustrate an example flowcharts for creating the location fingerprint of FIG. 3. A location fingerprint may be created using a vehicle 124, mobile device 122, server 125, and any components or combinations thereof. Additional, different, or fewer acts may be included.

At act S101, a location is identified to associate with a location fingerprint. The processor 210 and/or processor 300 may receive data indicative of a location, for example from a communication interface 225 and/or communication interface 305. The communication interface 225 and/or communication interface 305 may be a means for receiving data indicative of a location. The processor 210 and/or processor 300 may include circuitry or a module or an application specific controller as a means for receiving data indicative of a location.

There may be any number of reasons for identifying a particular location to associate with a location fingerprint. For example, locations that have unique geographic features, such as, for instance, features that vary from surrounding locations by a certain degree, may work well with location fingerprints since sensor data from these locations are more likely to be indicative of a unique location as opposed to locations where sensor data is fairly common. Another reason for identifying a particular location to associate with a location fingerprint may be based on crowd migration or heavy traffic areas. For example, locations that are popular among users may contain more devices that may require location authentication or verification services. Another motivation for choosing one location over another to have a location fingerprint may be based on security and/or safety concerns. For example, locations that require security clearance or that are particularly dangerous may require location authentication or verification before allowing access to those locations. In these situations, using location fingerprints to authenticate or verify the device location may be beneficial. Public spaces may also be identified as locations worthy of a location fingerprint. There may also be local rules, regulations, or ordinances that require location fingerprints at certain locations. There may also not be any reason behind identifying a particular location to associate with a location fingerprint. For example, a user of a device or administrator of a server may identify any location of their choosing to associate with a location fingerprint. In one example, a location may not qualify to be associated with a location fingerprint. For instance, a location may not have enough, or any, sensor data available to associate with its location.

Act S101 may be performed automatically or manually, at any time. For example, in a mobile device 122, the processor 210 may identify a location automatically in response to the position circuitry 227 or the processor 210 detecting that the geographic position of the mobile device 122, or the vehicle 124 if the mobile device 122 in integrated into a vehicle 124, matches the geographic position of a unique location, popular location, or highly secure and/or dangerous location. This matching of geographic positions may be performed by the processor 210 and may include accessing a database, such as a relational database, that associates geographic position data with data indicative of a location being, for example, unique, popular, or highly secure and/or dangerous. This type of data may be available from map developers or other specific database developers. In another example, an individual, such as a user of a mobile device 122 or administrator of a server 125, may manually identify a location in act S101 using the communication interface 225 and/or communication interface 305. In this example, the individual may choose to create a location fingerprint in response to a need for location verification services at the identified location.

At act S103, sensor criteria are selected for the location identified in act S101. FIG. 9B illustrates an example flowchart for selecting sensor criteria.

At act S103a, a set of sensor data from a plurality of sensor data associated with the location identified in act S101 is chosen. The processor 210 and/or processor 300 may receive data indicative of a choice of a set sensor data, for example from a communication interface 225 and/or communication interface 305. The communication interface 225 and/or communication interface 305 may be a means for receiving data indicative of a choice of a set sensor data. The processor 210 and/or processor 300 may include circuitry or a module or an application specific controller as a means for receiving data indicative of a choice of a set sensor data. The sensor data may contain attributes of the particular location able to be sensed or may identify particular types of sensor to ping at a location.

At act S103b, at least one threshold relating to the set of sensor data associated with the location identified in act S101 is set. The processor 210 and/or processor 300 may receive data indicative of a threshold, for example from a communication interface 225 and/or communication interface 305. The communication interface 225 and/or communication interface 305 may be a means for receiving data indicative of a threshold. The processor 210 and/or processor 300 may include circuitry or a module or an application specific controller as a means for receiving data indicative of a threshold. As described above, a threshold may include a predefined value or range of values for the set of sensor data chosen at act S103a in addition to either a predefined amount of sensor data associated with the location identified in act S101, a predefined type of sensor data associated with the location identified in act S101, or a predefined amount and a predefined type of sensor data associated with the location identified in act S101.

Acts S103a and S103b may be performed based on the characteristics, or attributes, of the sensor data. For example, if the location identified in act S101 is a unique location, as described above, the set of sensor data chosen for that location in act S103a may be the sensor data indicative of the uniqueness of that location, as opposed to sensor data associated with that location that is fairly common to other locations as well. In another example, if the location identified in act S101 is a popular location, as described above, the set of sensor data chosen for that location in act S103a may be the sensor data indicative of what makes that location popular. For example, the Skydeck of the Willis (formerly Sears) Tower in Chicago, Ill. may be deemed popular based on at least its height, or elevation. In this example, the set of sensor data chosen at act S103a may include at least elevation data, or may identify an altitude sensor to ping at this location. Similarly, the threshold set in act S103b is based on the sensor data chosen at act S103a. In this example, for instance, the threshold may be an elevation threshold that includes a minimum elevation value that must be satisfied, such as, for example, at least 1,350 feet high. Alternatively or additionally, the threshold set in act S103b may include a predefined amount of sensor data and/or a predefined type of sensor data. In yet another example, if the location identified in act S101 is a highly secure and/or dangerous location, as described above, the set of sensor data chosen for that location may be the sensor data indicative of what makes that location highly secure and/or dangerous.

Acts S103a and S103b may be performed automatically or manually. For example, in a mobile device 122, the processor 210 may choose a set of sensor data or set a threshold automatically in response to the position circuitry 227 or the processor 210 detecting that the geographic position of the mobile device 122, or the vehicle 124 if the mobile device 122 in integrated into a vehicle 124, matches the geographic position of a unique location, popular location, or highly secure and/or dangerous location. This matching of geographic positions may be performed by the processor 210 and may include accessing a database, such as a relational database, that associates geographic position data with data indicative of a location being, for example, unique, popular, or highly secure and/or dangerous, including an association to the specific data that makes those locations unique, popular, or highly secure and/or dangerous. This type of data may be available from map developers or other specific database developers. In another example, an individual, such as a user of a mobile device 122 or administrator of a server 125, may manually choose a set of sensor data or set a threshold in acts S103a and S103b using the communication interface 225 and/or communication interface 305.

At act S105, sensor criteria selected in act S103 is associated with the location identified in act S101. The association may be performed by the processor 210 and/or processor 300. The processor 210 and/or processor 300 may include circuitry or a module or an application specific controller as a means for associating the sensor criteria with the location.

At act S107, the sensor criteria selected in act S103 that is associated in act S105 with the location identified in act S101 is stored in database 123 and/or database 133. The associated sensor criteria may be stored in other types of databases as well. The processor 210 and/or processor 300 may include circuitry or a module or an application specific controller as a means for storing the associated sensor criteria.

### Verifying Location Using Location Fingerprints or Location Profiles

FIG. 10 illustrates an example flowchart for using the location fingerprint or location profile of FIG. 3 to verify a device location. As mentioned above, the term “location fingerprint” is synonymous with “location profile.” A location profile may be used by many different types of devices or applications, including a vehicle 124, mobile device 122, server 125, and any components or combinations thereof, to verify a location of a device. A location profile may also be used by a vehicle 124 or mobile device 122 to verify its own location. The device may be at one location, while purporting to be at another location. The method of FIG. 10 uses a location profile to verify whether the actual device location matches the purported device location. Additional, different, or fewer acts may be included.

At act S201, a predefined location profile created according to acts S101 to S107 of FIG. 9A is accessed. The processor 210 and/or processor 300 may access the predefined location profile from database 123 and/or database 133. The predefined location profile may be accessed from other types of databases as well. The processor 210 and/or processor 300 may include circuitry or a module or an application specific controller as a means for accessing a predefined location profile. The accessed predefined location profile may be associated with a purported device location.

At act S203, sensor data from a device is requested. The processor 210 and/or processor 300 may request sensor data from a device, such as a mobile device 122, vehicle 124, or a vehicle 124 having an integrated mobile device 122. The processor 210 and/or processor 300 may include circuitry or a module or an application specific controller as a means for requesting sensor data from a device. In one example, the type of sensor data requested by the processor 210 and/or processor 300 may correspond to the type of sensor data contained in the predefined location profile. In another example, the requested sensor data may be requested from sensors identified as sensors to ping in the predefined location profile. The amount and type of sensor data requested from a device is limited only by the amount and type of sensors included in the device. In one example, the processor 210 and/or processor 300 may request sensor data from a device at the actual device location. In another example, the processor 210 and/or processor 300 may request sensor data from a device that is stored in the memory 204 of the device. In this instance, while the device may be at one location, it is capable of providing sensor data associated with another location that the device has already been and has already collected and stored sensor data for that location.

At act S205, the device sensor data requested in act S203 is received. The processor 210 and/or processor 300 may receive the requested device sensor data. The processor 210 and/or processor 300 may include circuitry or a module or an application specific controller as a means for receiving the requested device sensor data.

At act S207, the device sensor data received in act S205 is compared with the location profile accessed in act S201. The processor 210 and/or processor 300 may compare the received device sensor data with the location profile. The processor 210 and/or processor 300 may include circuitry or a module or an application specific controller as a means for comparing the received device sensor data with the location profile. In one example, the processor 210 and/or processor 300 may compare the received device sensor data with the set of sensor data included in the predefined location profile associated with the purported device location. In another example, the processor 210 and/or processor 300 may compare the received device sensor data with at least one threshold relating to the sensor data included in the location profile associated with the purported device location. The comparison may also be based on the number or type of sensor data available from the device.

In another embodiment, the device sensor data received in act S205 for the actual device location is compared with external source data, such as sensor data, associated with the purported device location. The external source data may include sensor data from sensors at or near the purported device location. The external source data may also include calculated or estimated data associated with the purported device location, such as, for example, calculated or estimated temperature data for the purported device location. The processor 210 and/or processor 300 may compare the received device sensor data with the external source data. The processor 210 and/or processor 300 may include circuitry or a module or an application specific controller as a means for comparing the received device sensor data with the external source data.

At act S209, the device location is verified based on the comparison of act S207. The processor 210 and/or processor 300 may verify the device location. The processor 210 and/or processor 300 may include circuitry or a module or an application specific controller as a means for verifying the device location. In one example, the device location is verified when the actual device location matches the purported device location. For instance, the processor 210 and/or processor 300 may compare sensor data received from a device at the actual device location with sensor data, of the location profile, that is associated with the purported device location and determine, based on that comparison, whether the two sets of sensor data match up. In this instance, sensor data matches up when the types of sensor data and/or the amount of sensor data are the same for both sets of sensor data. When the sensor data matches, the device location is verified. In another example, the processor 210 and/or processor 300 may also compare the received device sensor data with at least one threshold, of the location profile, relating to the sensor data associated with the purported device location. In this example, the device location is verified when the received device sensor data meets or exceeds the at least one threshold of the location fingerprint.

In another embodiment, the processor 210 and/or processor 300 may compare sensor data received from a device at the actual device location with external source data, such as sensor data, associated with the purported device location and determine, based on that comparison, whether the two sets of sensor data match up. In this instance, sensor data matches up when the types of sensor data and/or the amount of sensor data are the same for both sets of sensor data. When the sensor data matches, the device location is verified. In another example, the external source data includes calculated or estimated data associated with the purported device location. In this instance, the device location is verified when the sensor data received from the device matches up with the calculated or estimated data associated with the purported device location.

In another example, the device location is not verified when the actual device location does not match the purported device location. For instance, the processor 210 and/or processor 300 may compare sensor data received from a device at the actual device location with sensor data, either of the location profile or from an external source, that is associated with the purported device location and determine, based on that comparison, whether the two sets of sensor data match up. In this instance, sensor data does not match up when the types of sensor data and/or the amount of sensor data are not the same for both sets of sensor data. Remediation may be allowed if a device location is not verified. For instance, new sensor data may be requested from the device at a later time to allow for the device to be at the location where the device claims to be.

Once the processor 210 and/or processor 300 of a mobile device 122 or server 125 has determined that the sensor data received from a device at the actual device location matches up with sensor data of the location profile that is associated with the purported device location, the mobile device 122 or server 125 may communicate the result, such as whether a location is verified, to vehicles 124 or mobile devices 122 from which the requested sensor data was received. The mobile device 122 or server 125 may also communicate the verification result to a map developer, third party, or any other service or service provider. The mobile device 122 or server 125 may generate a message as a means for communicating the verification result to the vehicles 124, mobile devices 122, map developer, third party, or other services or service providers. The generated message may contain, in addition to the result of the verification, what sensor data was compared to make such verification determination, such as the requested sensor data from one or more onboard sensor(s) 233 of vehicles 124 or mobile devices 122 and the sensor data and predefined threshold accessed from database 123, location information associated with this sensor data, and the time at which the verification determination was made. The generated message may also contain data indicative of which device, such as vehicle 124 or mobile device 122, or which service provider initiated the verification process and the devices or service providers that are receiving the verification result.

The mobile device 122 or server 125, in response to the determination described above, may also indicate the result of the determination in a database 123 and/or database 133, such as by adding a data layer or attribute, or any other data storage method. The mobile device 122 may also display this result on the display 221 or input device 223, or by opening a mobile application. Depending on the result of the determination, the mobile device 122 or server 125 may also limit functionality of the mobile device 122 or server 125, or applications running thereon, in response to whether the device location is verified.

The method of using a predefined profile to verify a location according to acts S201 to S209 of FIG. 10 may be performed automatically. For example, in a mobile device 122, the processor 210 may start the verification process automatically in response to the position circuitry 227 or the processor 210 detecting that the geographic position of the mobile device 122, or the vehicle 124 if the mobile device 122 in integrated into a vehicle 124, matches the geographic position of a location associated with a predefined location profile. In this regard, autonomous vehicles, as described in detail above, may be able to automatically verify their location as they travel past locations having predefined location profiles associated with them. This provides an additional security measure to protect autonomous vehicles from potential hostile purposes or fraudulent activity.

The use of predefined location fingerprints to determine or verify a location has broad applications in the location referencing or tracking industry and provides many benefits. The service, device, or application using location fingerprints to determine or verify a location may require different types of location fingerprints, or different levels of sensor criteria included in the location fingerprints.

For example, location fingerprints may be used as an additional level of security for already existing location referencing or tracking applications. For instance, given that GPS tracking systems are prone to errors and inaccuracies as described above, GPS tracking providers may offer the use of location fingerprints as an added security layer to tracking or verifying a device location. These added layers of security may be offered at different levels. For instance, to slightly increase or improve the accuracy of location tracking, a GPS tracking provider may offer location fingerprints having only one type of sensor data, such as temperature, or one type of sensor to ping, such as a temperature sensor. In this regard, sensor data from a user device would only need to match either temperature sensor data in the location fingerprint or external temperature source data associated with the user device location, which is a low level of sensor criteria. Alternatively or additionally, the GPS tracking provider may offer location fingerprints having 3 or more types of sensor data included in the location fingerprint, such as temperature, elevation, and lighting, or three types of sensors to ping, such as a temperature sensor, an altitude sensor, and a lighting sensor. In that instance, the sensor criteria is much higher and requires the user device to match significantly more sensor data with either the sensor data contained in the location fingerprint or external source/sensor data associated with the user device location. This offers a higher level of security. In most cases, the higher level of security (i.e., the increased amount of sensor data being required to match) is typically purchased from a provider at a higher cost than lower levels, such as those levels that only require one type of sensor data to match.

As discussed above, location fingerprints may also be used to prevent intentional GPS spoofing or jamming attacks. For example, if a user manipulates a device in a way that allows the device to report its location to a service provider in a false manner, the use of location fingerprints would alert the service provider that something is wrong. Preventing spoofing or jamming attacks applies to various applications. For example, if a weaponized drone were to be hacked and manipulated to report its location in hostile territory, thus allowing the weaponry features to be activated as discussed below, the hacker could potentially use the drone to perform attacks on civilians in non-hostile locations. However, requiring the drone to verify its location using location fingerprints would alleviate this problem, since the drone location may not be verified, thus preventing the weaponry features to be activated, as discussed below.

In a less serious example, using location fingerprints as an anti-spoofing technique is also applicable to online or collaborative gaming systems, such as location-based augmented reality games. For example, some games allow players to use a GPS enabled mobile device to locate and capture various virtual characters that appear on-screen to be in the same physical location as the player. By spoofing the GPS location of the mobile device, players are able to appear to be anywhere in the world at any given time, which allows players to cheat and capture virtual characters from all over the world without leaving a couch.

Location fingerprints may be employed in a variety of other services. Some of these services are listed below. This list is not exhaustive, as the uses for location fingerprints are extensive. Location fingerprints apply to any situation in which a location needs to be determined or verified.

Logistics and fleet management services may employ the use of location fingerprints since a vast amount of their business is focused on knowing where their vehicles are located.

As described throughout this specification, there are a number of applications of location fingerprints in the field of autonomous vehicles. Autonomous vehicles depend on location information to function properly, so determining and verifying a vehicle location is key in this industry.

Emergency vehicles may also employ location fingerprints. For instance, when responding to an accident or other critical situation, it is important for the emergency vehicle to know exactly where it needs to go. Location fingerprints may be used to verify that location.

There are many traffic related services that may benefit from location fingerprints. For example, location fingerprints may be used in intelligent parking or tolling systems. In one example, parking garages or lots may assign location fingerprints unique for each parking space, which improves the process of finding a parked car in a packed parking garage or parking lot. In another example, location fingerprints are used to ensure a vehicle should be charged with a toll, depending on the vehicle location. Traffic maps may also be generated or augmented using location fingerprints. For instance, once a vehicle location is authenticated using a location fingerprint, speed and other traffic condition data may be sent to the traffic map developer. Also, as described below, vehicles may report traffic incidents once their location is verified.

Military endeavors, including drones, may benefit from using location fingerprints. The accuracy of data, including location data, is critical to missions, such as drone strikes. Location fingerprints may be used to verify the accuracy of such location data.

Taxi and ridesharing companies may use location fingerprints as well. For example, a common problem associated with taxi and ridesharing services is that the driver reports to be at a location to pick up a fare, but the driver is not actually at that location. In this example, either the driver or the fare may utilize location fingerprints to verify the location of the other.

Smart cars, or users communicating with their vehicles, is another area ripe for improvement using location fingerprints. For instance, vehicles with proximity sensing technology may benefit from location fingerprints, as discussed below. These vehicles also currently utilize GPS tracking systems and, as described above, location fingerprints offer an improvement over this technology.

Dating and social media websites, applications and services may also incorporate location fingerprints. Location fingerprints may be used to verify locations of users with respect to each other, particularly for enabling certain functions, as described below.

The farming industry may also benefit from using location fingerprints. In one example, farmers may want to track the location of their livestock. In another example, large farms may want a detailed and accurate map of their property to manage data such as the location of certain crops or the number and location of maple syrup tubing lines.

Different types of location fingerprint services require different types of location fingerprints. For example, emergency vehicles may require location fingerprints having an increased amount of required sensor criteria, or an increased number of sensors to ping, than location fingerprints utilized in dating or social media services. Given the security and safety concerns regarding drones, those types of applications may require a location fingerprint threshold that is harder to meet than those in taxi or ridesharing location fingerprints.

Within each particular application or use, such as those described above, the location fingerprint may be used for functions other than just location verification. For example, with autonomous vehicles, in addition to verifying the vehicle location, a location fingerprint may be required before the user is able to switch from a manual mode, or HAD mode, to a self-driving or driverless mode in which no passengers are required to be on board to operate the vehicle. One example of this situation is when a vehicle is determined to be in a relatively traffic free area of a road segment with a constant speed limit for an extended distance, since the dangers of operating without human intervention in this scenario is limited.

In another example pertaining to the use of drones in military action, using a location fingerprint may be required before the drone may be operated in attack mode, such as engaging the weaponry functions like guns and missiles, to ensure the drone does not attack or engage civilians in a non-hostile environment.

In another example, location fingerprints may be used to not only verify the location of a parked car, but the location fingerprint may also allow a user to unlock or start the car when they, or their mobile device they are carrying, are determined to be in close proximity to the vehicle. In some instances, this can be automatic. For example, a user may carry a mobile device that communicates with the vehicle of the user. As soon as the mobile device gets within a certain proximity of the vehicle, the vehicle may unlock or start automatically.

In another example using social media, users of web-based applications may use location fingerprints to access certain features. For example, in an online dating or networking application, before a first user is able to access contact information of a second user, the first user must be deemed to be in close proximity, such as the same city or zip code, as the second user.

Using location fingerprints to access certain features in addition to location verification also has value in database development. For instance, location fingerprints may be used to not only authenticate a location, but also to allow a user to make changes to a map only after a user location is verified, such as identifying a point of interest, changing the name of a street, adding or changing a business name, etc.

Traffic management is another area where using location fingerprints offers benefits in addition to verifying locations. For instance, a location fingerprint may be used to authenticate a user location in order to allow the user to report speed or traffic incidents, such as accidents, stalled motorists, the presence of emergency vehicles, and speed traps (i.e., the presence of law enforcement vehicles).

In one example, an application may use location fingerprints for different uses and at different levels. For example, in a traffic application on a device, a low-level location fingerprint may be used to verify the device location if the traffic application is used for navigation purposes, since the traffic routing features only affect the device using the traffic application. However, when that traffic application is used for reporting a traffic incident or emergency vehicle on the road, the device location may be verified using a medium-level location fingerprint, since this affects the routing of other users and devices in that area and may be deemed more important than low-level verification. Similarly, if the traffic application is used to report a change in a road or road attribute, as described above, the device location may be verified using a high-level location fingerprint, since modifying a map database and associated map affects all users of that map for a long period of time, and may be deemed more important than medium-level verification.

In addition to the benefits of increased accuracy of location verification and the added security to prevent against spoofing and/or jamming, location fingerprints may also provide unique benefits to users depending on the application in which the fingerprints are used. For instance, a data collection company may provide incentives to users who verify their location using a location fingerprint. The data collection company may also provide additional incentives to users who provide sensor data at their confirmed location. As described above, this is an easy and automatic way for a database developer to build their collection of sensor data at various locations. In another example, providers of augmented reality services or collaborative video games may provide incentives to users who contribute location related information from their verified location. In yet another example, taxi or ridesharing companies may offer incentives to users who utilize location fingerprints to verify their location, since doing so reduces the chances that the driver receives inaccurate location information from the rider.

As shown above, there is a vast amount of applications and benefits associated with using location fingerprints, and the technical developments presented herein offer an improvement over existing GPS technology as well as a solution to spoofing or jamming attacks.

Referring back to FIG. 2, in some alternatives, additional sensors may be included in the vehicle 124. An engine sensor 111 may include a throttle sensor that measures a position of a throttle of the engine or a position of an accelerator pedal, a brake sensor that measures a position of a braking mechanism or a brake pedal, or a speed sensor that measures a speed of the engine or a speed of the vehicle wheels. Another additional example, vehicle sensor 113, may include a steering wheel angle sensor, a speedometer sensor, or a tachometer sensor. The vehicle sensor 113 may include a microphone, an internal camera, or another sensor to detect the internal environment of the vehicle 124.

The mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may response to geographic data received from geographic database 123 and the server 125, which may have been updated. The assisted driving vehicle may be selected a route based on any of the examples herein, including in response to activity selections.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order to pass the initial observation location or road object in response to the request for additional observations.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and the request for additional observations for the road object.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle either on a roadway or within a road network system.

One example of a simple system includes the functional classification maintained by the United States Federal Highway administration. The simple system includes arterial roads, collector roads, and local roads. The functional classifications of roads balance between accessibility and speed. An arterial road has low accessibility but is the fastest mode of travel between two points. Arterial roads are typically used for long distance travel. Collector roads connect arterial roads to local roads. Collector roads are more accessible and slower than arterial roads. Local roads are accessible to individual homes and business. Local roads are the most accessible and slowest type of road.

An example of a complex functional classification system is the urban classification system. Interstates include high speed and controlled access roads that span long distances. The arterial roads are divided into principle arteries and minor arteries according to size. The collector roads are divided into major collectors and minor collectors according to size. Another example functional classification system divides long distance roads by type of road or the entity in control of the highway. The functional classification system includes interstate expressways, federal highways, state highways, local highways, and local access roads. Another functional classification system uses the highway tag system in the Open Street Map (OSM) system. The functional classification includes motorways, trunk roads, primary roads, secondary roads, tertiary roads, and residential roads.

Referring back to FIG. 5, the mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

Communication between the mobile device 122 and the server 125 through the network 127 may use a variety of types of wireless networks. Example wireless networks include cellular networks, the family of protocols known as WiFi or IEEE 802.11, the family of protocols known as Bluetooth, or another protocol. The cellular technologies may be analog advanced mobile phone system (AMPS), the global system for mobile communication (GSM), third generation partnership project (3GPP), code division multiple access (CDMA), personal handy-phone system (PHS), and 4G or long term evolution (LTE) standards, or another protocol.

The processor 210 and/or processor 300 may include a general processor, digital signal processor, an application specific integrated circuit (ASIC), field programmable gate array (FPGA), analog circuit, digital circuit, combinations thereof, or other now known or later developed processor. The processor 210 and/or processor 300 may be a single device or combinations of devices, such as associated with a network, distributed processing, or cloud computing.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 801 may be removable from the mobile device 122, such as a secure digital (SD) memory card.

The communication interface 225 and/or communication interface 305 may include any operable connection. An operable connection may be one in which signals, physical communications, and/or logical communications may be sent and/or received. An operable connection may include a physical interface, an electrical interface, and/or a data interface. The communication interface 225 and/or communication interface 305 provides for wireless and/or wired communications in any now known or later developed format.

The input device 223 may be one or more buttons, keypad, keyboard, mouse, stylus pen, trackball, rocker switch, touch pad, voice recognition circuit, or other device or component for inputting data to the mobile device 122. The input device 223 and display 221 may be combined as a touch screen, which may be capacitive or resistive. The display 221 may be a liquid crystal display (LCD) panel, light emitting diode (LED) screen, thin film transistor screen, or another type of display. The output interface of the display 221 may also include audio capabilities, or speakers. In an embodiment, the input device 223 may involve a device having velocity detecting abilities.

The positioning circuitry 227 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 227 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 227 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 227 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

The following example embodiments of the invention are also disclosed:

### Embodiment 1

A method of verifying a device location. The method comprising: accessing, by a processor, a predefined location fingerprint for a purported location, wherein the predefined location fingerprint includes sensor criteria associated with the purported location, the sensor criteria including at least one threshold, the at least one threshold relating to sensor data associated with the purported location; requesting, by the processor, device sensor data from one or more device sensors of a device; receiving, by the processor, the requested device sensor data from the device; comparing, by the processor, the received device sensor data with the at least one threshold relating to the sensor data associated with the purported location; and verifying, by the processor based on the compared device sensor data and the at least one threshold relating to the sensor data associated with the purported location, the device location in response to the received device sensor data meeting or exceeding the at least one threshold.

### Embodiment 2

The method of embodiment 1, further comprising: sending an external data request to an external provider for the sensor data associated with the purported location; and receiving the sensor data associated with the purported location from the external provider.

### Embodiment 3

The method of embodiment 1 or 2, wherein the location fingerprint is predefined by identifying a purported location to associate with the location fingerprint, selecting sensor criteria for the purported location, and associating the sensor criteria with the purported location as the location fingerprint.

### Embodiment 4

The method of any of the preceding embodiments 1 to 3, wherein the at least one threshold comprises a predefined value or range of values for the sensor data associated with the purported location and either a predefined amount of sensor data associated with the purported location, a predefined type of sensor data associated with the purported location, or a predefined amount and a predefined type of sensor data associated with the purported location.

### Embodiment 5

The method of any of the preceding embodiments 1 to 4, wherein the sensor data associated with the purported location is collected from a set of sensors and the one or more device sensors correspond to the set of sensors.

### Embodiment 6

The method of any of the preceding embodiments 1 to 5, wherein the purported location is a point of interest or a pre-defined area.

### Embodiment 7

The method of any of the preceding embodiments 1 to 6, wherein the sensor data associated with the purported location comprises environmental attributes associated with the purported location.

### Embodiment 8

The method of any of the preceding embodiments 1 to 7, wherein verifying the device location is performed by the device automatically when the device location corresponds to a location associated with a location fingerprint.

### Embodiment 9

An apparatus comprising: a database; a location fingerprint associated with a location, the location fingerprint including sensor criteria associated with the location, wherein the location fingerprint is stored in the database; and at least one processor configured to access the location fingerprint from the database, ping a device for device sensor data based on the sensor criteria of the location fingerprint, receive device sensor data from the device, compare the received device sensor data with external source data associated with the location, and verify the device is at the location based on the compared device sensor data and external source data.

### Embodiment 10

A method of creating a location fingerprint, the method comprising: identifying a location to associate with the location fingerprint; selecting sensor criteria for the location, wherein the sensor criteria includes a set of sensor data from a plurality of sensor data associated with the location and at least one threshold relating to the set of sensor data associated with the location; associating the sensor criteria with the location as the location fingerprint; and storing the location fingerprint in a database.

### Embodiment 11

The method of embodiment 10, wherein the location is a point of interest or a pre-defined area.

### Embodiment 12

The method of embodiment 10 or 11, wherein the sensor data associated with the location comprises environmental attributes associated with the location.

### Embodiment 13

The method of any of the preceding embodiments 10 to 12, further comprising: accessing, in response to a request to verify a purported location of a device, the location fingerprint stored in the database; requesting device sensor data from one or more device sensors, the requested device sensor data corresponding to the set of sensor data; receiving the requested device sensor data from the device; comparing the received device sensor data with the at least one threshold; and verifying, based on the compared device sensor data and the at least one threshold, the device location in response to the received device sensor data meeting or exceeding the at least one threshold.

### Embodiment 14

The method of any of the preceding embodiments 10 to 13, further comprising collecting the plurality of sensor data from one or more sensors within sensing range of the location.

### Embodiment 15

The method of any of the preceding embodiments 10 to 14, wherein the one or more sensors comprise either one or more vehicle sensors from a vehicle or one or more mobile device sensors from a mobile device and wherein collecting the plurality of sensor data is performed automatically by receiving sensor data associated with the location from either the one or more vehicle sensors or the one or more mobile device sensors when either the vehicle or the mobile device is within sensing range of the location.

### Embodiment 16

The method of any of the preceding embodiments 10 to 15, wherein collecting the plurality of sensor data is performed by providing the one or more sensors at the location to collect the plurality of sensor data associated with the location.

### Embodiment 17

The method of any of the preceding embodiments 10 to 16, wherein collecting the plurality of sensor data is performed semi-automatically by receiving sensor data associated with the location from either one or more vehicle sensors of a vehicle or one or more mobile device sensors from a mobile device when either the vehicle or the mobile device is within sensing range of the location and by providing one or more sensors at the location to collect sensor data associated with the location.

### Embodiment 18

The method of any of the preceding embodiments 10 to 17, wherein storing further comprises storing the associated sensor criteria as an attribute or as a data layer for the location.

### Embodiment 19

The method of any of the preceding embodiments 10 to 18, wherein the plurality of sensor data associated with the location is stored in a map or geographic database.

### Embodiment 20

An apparatus comprising: a database; a communication interface to receive at least one selection of a location and at least one selection of sensor criteria for the location; and at least one controller coupled to the communication interface and database, the at least one controller to associate the at least one selection of the location and the at least one selection of sensor criteria with the location as a location profile, and to store the location profile in the database.

We claim:

1. A method of verifying a device location, the method comprising:
accessing, by a processor, a predefined location fingerprint for a purported location, wherein the predefined location fingerprint includes sensor criteria associated with the purported location, the sensor criteria including at least one threshold, the at least one threshold relating to sensor data associated with the purported location;
requesting, by the processor, device sensor data from one or more device sensors of a device;
receiving, by the processor, the requested device sensor data from the device;
comparing, by the processor, the received device sensor data with the at least one threshold relating to the sensor data associated with the purported location; and
verifying, by the processor based on the compared device sensor data and the at least one threshold relating to the sensor data associated with the purported location, the device location in response to the received device sensor data meeting or exceeding the at least one threshold.

2. The method of claim 1, further comprising:
sending an external data request to an external provider for the sensor data associated with the purported location; and
receiving the sensor data associated with the purported location from the external provider.

3. The method of claim 1, wherein the location fingerprint is predefined by identifying a purported location to associate with the location fingerprint, selecting sensor criteria for the purported location, and associating the sensor criteria with the purported location as the location fingerprint.

4. The method of claim 1, wherein the at least one threshold comprises a predefined value or range of values for the sensor data associated with the purported location and either a predefined amount of sensor data associated with the purported location, a predefined type of sensor data associated with the purported location, or a predefined amount and a predefined type of sensor data associated with the purported location.

5. The method of claim 1, wherein the sensor data associated with the purported location is collected from a set of sensors and the one or more device sensors correspond to the set of sensors.

6. The method of claim 1, wherein the purported location is a point of interest or a pre-defined area.

7. The method of claim 1, wherein the sensor data associated with the purported location comprises environmental attributes associated with the purported location.

8. The method of claim 1, wherein verifying the device location is performed by the device automatically when the device location corresponds to a location associated with a location fingerprint.

9. An apparatus comprising:
a database;
a location fingerprint associated with a location, the location fingerprint including sensor criteria associated with the location, wherein the location fingerprint is stored in the database; and
at least one processor configured to access the location fingerprint from the database, ping a device for device sensor data based on the sensor criteria of the location fingerprint, receive device sensor data from the device, compare the received device sensor data with external source data associated with the location, and verify the device is at the location based on the compared device sensor data and external source data.

10. A method of creating a location fingerprint, the method comprising:
identifying a location to associate with the location fingerprint;
selecting sensor criteria for the location, wherein the sensor criteria includes a set of sensor data from a plurality of sensor data associated with the location and at least one threshold relating to the set of sensor data associated with the location;
associating the sensor criteria with the location as the location fingerprint; and
storing the location fingerprint in a database.

11. The method of claim 10, wherein the location is a point of interest or a pre-defined area.

12. The method of claim 10, wherein the sensor data associated with the location comprises environmental attributes associated with the location.

13. The method of claim 10, further comprising:
accessing, in response to a request to verify a purported location of a device, the location fingerprint stored in the database;
requesting device sensor data from one or more device sensors, the requested device sensor data corresponding to the set of sensor data;
receiving the requested device sensor data from the device;
comparing the received device sensor data with the at least one threshold; and
verifying, based on the compared device sensor data and the at least one threshold, the device location in response to the received device sensor data meeting or exceeding the at least one threshold.

14. The method of claim 10, further comprising collecting the plurality of sensor data from one or more sensors within sensing range of the location.

15. The method of claim 14, wherein the one or more sensors comprise either one or more vehicle sensors from a vehicle or one or more mobile device sensors from a mobile device and wherein collecting the plurality of sensor data is performed automatically by receiving sensor data associated with the location from either the one or more vehicle sensors or the one or more mobile device sensors when either the vehicle or the mobile device is within sensing range of the location.

16. The method of claim 14, wherein collecting the plurality of sensor data is performed by providing the one or more sensors at the location to collect the plurality of sensor data associated with the location.

17. The method of claim 14, wherein collecting the plurality of sensor data is performed semi-automatically by receiving sensor data associated with the location from either one or more vehicle sensors of a vehicle or one or more mobile device sensors from a mobile device when either the vehicle or the mobile device is within sensing range of the location and by providing one or more sensors at the location to collect sensor data associated with the location.

18. The method of claim 10, wherein storing further comprises storing the associated sensor criteria as an attribute or as a data layer for the location.

19. The method of claim 10, wherein the plurality of sensor data associated with the location is stored in a map or geographic database.

20. An apparatus comprising:
a database;
a communication interface to receive at least one selection of a location and at least one selection of sensor criteria for the location; and
at least one controller coupled to the communication interface and database, the at least one controller to associate the at least one selection of the location and the at least one selection of sensor criteria with the location as a location profile, and to store the location profile in the database.
